(19) United States
(12) Patent Application Publication
(10) Pub. No.: US 2019/0182298 A1
(43) Pub. Date: Jun. 13, 2019

(54) METHOD FOR SUPPORTING REAL-TIME MATCHING BETWEEN INSTRUCTOR AND STUDENT IN TELEPHONY LECTURE

(71) Applicant: Byung Jin MOON, Gyeonggi-do (KR)

(72) Inventor: Byung Jin MOON, Gyeonggi-do (KR)

(21) Appl. No.: 16/280,832

(22) Filed: Feb. 20, 2019

Related U.S. Application Data
(63) Continuation-in-part of application No. PCT/KR2017/009183, filed on Aug. 23, 2017.

(30) Foreign Application Priority Data
Aug. 25, 2016 (KR) 10-2016-0108028

(51) Int. Cl. H04L 29/06

(52) U.S. Cl. CPC H04L 65/1069; H04L 65/4084; H04L 65/1053; H04L 65/1076; H04L 65/1006

(57) ABSTRACT

Disclosed is a method for supporting a real-time lecture on any subject via telephone, in which if an instructor expresses, via a terminal, an intention to currently provide a lecture to a list of lecture available subjects that have been previously registered: a process of measuring an expected quality of media traffic between an

Internet telephone server and an instructor terminal and quantifying and storing the same is added, and if a student who wants a real-time lecture on any subject chooses an instructor from a list of currently lecture available instructors for the subject in accordance with an expected telephone call quality or his/her preferences, and requests a real-time lecture with simple additional information such as a subject or a lecture time, the instructor accepts the lecture after confirming the additional information; before performing an actual telephone connection, an expected quality of the media traffic between the instructor terminal and a student terminal is measured, and when the expected quality is below a predetermined reference value, the instructor and the student are notified, and when the expected quality meets the reference value or the instructor and the student agree, it is supported to connect a telephone for a real-time lecture between the instructor and the student; and in the case of an ordinary telephone, only an actual telephone connection is supported.

### CROSS REFERENCE TO RELATED APPLICATION

This application is a continuation-in-part of PCT International Patent Application Serial No. PCT/KR2017/009183, filed Aug. 23, 2017, the contents of which are incorporated herein.

### TECHNICAL FIELD

Embodiments of the present invention relate to a telephony lecture system including a method for a real-time matching between an instructor or service provider having an intention to provide a lecture or telephony service in a form of real-time conversation over the phone with respect to a specialized subject field registered by an instructor member when signing up for a membership and a student or service consumer requesting a lecture about a predetermined subject field when providing a telephony lecture service, and more particularly, to a telephony lecture system including several methods of expressing an intention to provide a real-time lecture through a telephone terminal by an instructor, a method of incorporating a call quality prediction index for each instructor when a student searches a list of instructors to provide a real-time lecture with respect to a specialized subject field, and further a method of notifying an instructor of a request for a lecture when a student selects the instructor.

### BACKGROUND ART

In comparison to a general analog telephone, an Internet telephone using the SIP is relatively inexpensive or free of charge in a predetermined circumstance. The SIP itself provides a huge expandability to add a new function or service, when compared to an analog telephone service, Further, it is very easy for a private enterprise to construct an Internet telephone server by utilizing IP PBX and establish an independent internal IP telephone network using a unique phone number system such as extension numbers. A call between extension numbers does not incur any call charge. Extension numbers of the analog telephone service are physically limited to be used inside a predetermined building, whereas extension numbers of an IP telephone service may exist wherever in the world. A method for a real-time matching between an instructor and a student is implemented by configuring a system provided herein using advantages such as internal telephone network establishment without spatial restriction, the expandability of the SIP, and cost efficiency in service construction and provision. However, when compared to a circuit switching analog telephone which uses a channel with a fixed bandwidth assigned in advance, a packet switching Internet Protocol based telephone always has an issue of call quality. Herein, a solution to the issue of call quality by calculating a call quality prediction index for each instructor, providing the calculated call quality prediction index to a student, and allowing the student to select an optimal instructor is suggested.

Prior Art Document: JP Patent Application Publication No. 2008-129081 Interactive Lecture Support System

### DISCLOSURE OF INVENTION

### Technical Goals

An aspect of the present invention provides a method that may allow an instructor, having an intention to provide a real-time lecture using a telephone, and a student, having an intention to request a lecture, to provide and request a lecture at desired times and desired locations, without time and location restrictions.

### Technical Solutions

To solve the foregoing, the present invention allows an instructor member to act as an instructor at a predetermined time and a predetermined location through a real-time lecture provision or service provision by telephone intention expression, calculates call quality prediction indices of instructors expressing an intention to provide a real-time lecture and provides a list of the instructors along with the calculated call quality prediction indices to a student such that the student may select an instructor considering the same, and transfers, when a student selects a predetermined instructor and requests a lecture, information related to a request for the lecture (student ID, a lecture subject or service subject, a lecture time or service time, a detailed question) to the instructor such that the instructor may consider the transferred information and conveniently decline the request for the lecture in an emergency situation.

The lecture provision intention expression may use an existing telephone server system as is by utilizing a feature code or an ARS when a telephone server is to be used, or may be easily implemented through a simple modification or a function addition to an Internet telephone server program and a general-purpose SIP Client program by utilizing the expandability of the SIP, and may be implemented using the HTTP or an internal protocol, when a service providing server is to be used.

Call qualities may be predicted by measuring the same in a section between the Internet telephone server and an instructor terminal or service provider terminal and provided as instructor information when a student searches a list of instructors related to a predetermined subject field such that the student may select an instructor considering the same. A call quality state of a student terminal or service consumer terminal may also be measured in a section between the Internet telephone server and a student terminal and provided to the student.

The information related to the request for the lecture from the student may be transferred by utilizing the expandability of the SIP when the Internet telephone server is to be used, or using the HTTP or the internal protocol when the service providing server is to be used.

### Effects

According to embodiment, a service, such as a telephone English service, may allow an instructor and a student to provide and request a lecture at desired times and desired locations, rather than a fixed schedule.

A student may select an instructor depending on a preference at a predetermined time and predetermined location if a wired or wireless Internet connection is available, and

an Internet instructor may provide a lecture at a predetermined time and predetermined location if a wired or wireless Internet connection is available. Obviously, telecommuting is 100% possible, and the burden of call charge may be released by utilizing an Internet telephone.

An existing Internet telephone is likely to have an issue of call quality. Herein, however, an optimal matching may be supported by providing a method of predicting a call quality such that the student may achieve a desired goal at a lower cost.

In a system of the present invention, a member is basically a student. A member having an ability to provide a lecture with respect to a predetermined subject field to many and unspecified persons stores information related to the predetermined subject field in a member information database (DB), expresses an intention to provide a lecture using several lecture provision intention expression methods provided herein, acts as an instructor, is included in a list of instructors when a student searches the list of instructors with respect to the predetermined subject field, and provides a lecture through a phone connection when the student requests the lecture. If the instructor has no intention to provide a lecture, the instructor may act as a student and take an interactive lecture from another instructor.

### BRIEF DESCRIPTION OF DRAWINGS

FIG. 1 illustrates service configuration blocks to implement a method for a real-time matching between an instructor and a student of a telephony lecture according to an embodiment. A telephone server may be a SIP Internet telephone server and a general analog telephone server in some examples.

FIG. 2 is a first-half flowchart of an overall message transmission and reception procedure among the service configuration blocks of FIG. 1 according to an embodiment, wherein the procedure includes an operation of expressing an intention to provide a lecture by an instructor who is currently able to provide a lecture, after an instructor terminal is available for a call through an operation of registering the SIP and further an operation of predicting a call quality between the instructor terminal and an Internet telephone server is performed, an operation of requesting a lecture including additional information (a lecture time, a lecture subject, a student ID) from a predetermined instructor based on a preference of a student after the student receives a list of instructors who are able to provide a lecture with respect to a predetermined subject field of which the student hopes to take a lecture, and an operation of accepting the lecture by the instructor after confirming the request for the lecture from the student. The portion of receiving a lecture provision intention expression of the instructor and lecture request information of the student may all be implemented using the SIP (event state change, event notification request, event notification response).

FIG. 3 is a second-half flowchart of the overall message transmission and reception procedure among the service configuration blocks of FIG. 1 when the instructor accepts the request for the lecture from the student according to an embodiment, wherein the corresponding information is notified to a student terminal, and a result of performing an operation of predicting a call quality between the instructor terminal and the student terminal is notified to each of the instructor terminal and the student terminal. The following process illustrates a method of call transfer of the Internet telephone using the SIP of IETF as is, wherein the Internet telephone server first performs a phone connection to the instructor accepting the lecture, and, if successful, performs a phone connection to the student again, thereby intervening a phone connection between the instructor and the student through the call transfer process which is the SIP standard procedure of IETF.

FIG. 4 is a second-half flowchart of the overall message transmission and reception procedure among the service configuration blocks of FIG. 1 when the instructor declines the request for the lecture from the student according to an embodiment.

FIG. 5 illustrates an operation of performing a lecture provision intention expression of an instructor through an automatic response system (ARS) implemented at a telephone server.

FIG. 6 illustrates an operation of performing a lecture provision intention expression of an instructor through a feature code assigned to a telephone server for the corresponding purpose.

FIG. 7 illustrates an operation of performing a lecture provision intention expression of an instructor by adding an extension header to a SIP Request message of a SIP Transaction or adding a Content type and recording Content of the corresponding type.

FIG. 8 illustrates an operation of performing a lecture request notification of a student by adding an extension header to a SIP Request message of a SIP Transaction or adding a Content type and recording Content of the corresponding type.

### BEST MODE FOR CARRYING OUT THE INVENTION

In a procedure in which a system implementing a method for supporting a real-time matching between an instructor and a student of a telephony lecture performs a matching task in reality,

a member having an intention to provide a lecture to many and unspecified persons as an instructor stores instructor information essentially including a specialized subject field and including other general personal information in a service providing server 3 when signing up for a membership, and in case of the Internet telephone, an instructor terminal 1 performs a SIP registration operation in an Internet telephone server 2 and predicts, quantifies, and then stores a call quality between an Internet telephone server 2 and the instructor terminal 1 when the instructor terminal 1 is available for a call. Call quality prediction indices may be measured periodically and updated continuously. Similarly, a student terminal 4 may also predict and quantify a call quality between the Internet telephone server 2 and the student terminal 4 and provide the call quality to the student terminal 4 through interoperation between the Internet telephone server 2 and the service providing server 3.

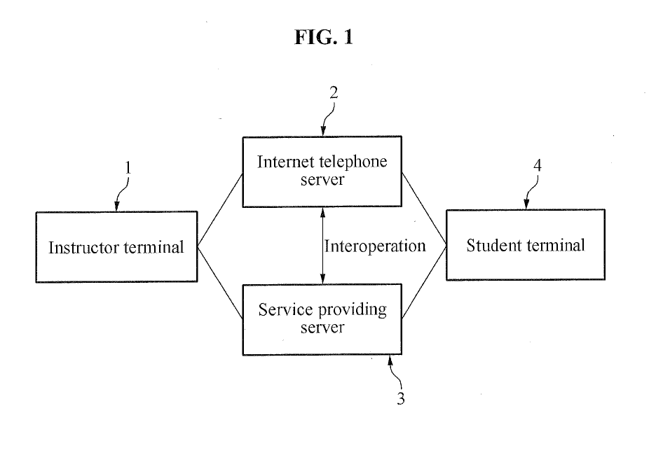

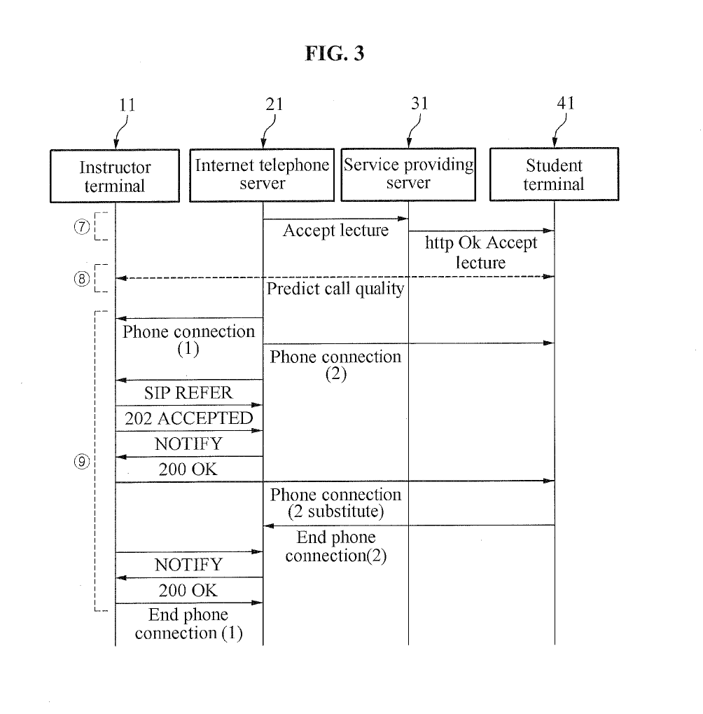

In FIG. 1, the Internet telephone server 2 is designed as a very complex network when implemented by a real telecommunications company. In this circumstance, when a call quality of the instructor terminal 1 or the student terminal 4 in a call waiting state is to be predicted, the Internet telephone server 2 corresponds to Proxy Call Session Control Function (P-CSCF) in case of a mobile communication network, a SIP Proxy server in case of a general wired network, an Internet Protocol Private Branch Exchange (IP PBX) in case of a private enterprise, or a Session Border Controller (SBC) additionally disposed to solve an NAT Traversal issue, as a SIP object to chat with first when viewed from an aspect of the instructor terminal 1 or the student terminal 4. Considering that such a SIP object relays a media in many cases during a real call due to the issue such as NAT Traversal, the instructor terminal 1 or the student terminal 4 predicts a call quality with respect to a section between the instructor terminal 1 or the student terminal 4 and the Internet telephone server 2 (the SIP object) as a concept of longest distance of a common media transmission section irrespective of a phone connection to any person, and uses the same as a criterion for the call quality of the instructor terminal 1 or the student terminal 4 in the call waiting state. A transmission test session for call quality prediction may be generated through a method of exchanging a SIP Transaction between the instructor terminal 1 or the student terminal 4 and the Internet telephone server 2. That is, the transmission test session may be generated through an operation in which the instructor terminal 1 or the student terminal 4 transfers a SIP Transaction Request including a request for call quality prediction, and the server responds with a terminal by incorporating its own IP address and Port number for generating of the transmission test session in a SIP Transaction Response. For a detailed call quality prediction operation, reference may be made to the description of operation \textcircled{8} of FIG. 3.

An instructor transfers, through the instructor terminal 1 to the telephone server 2 or the service providing server 3, whether the instructor has an intention to provide a lecture, which changes in real time. In either case, information is shared through interoperation between the two servers. When a student searches a list of instructors who is currently available for a lecture with respect to a specialized subject field through the service providing server 3, an instructor is added to or deleted from the list based on whether the instructor has an intention to currently provide a lecture.

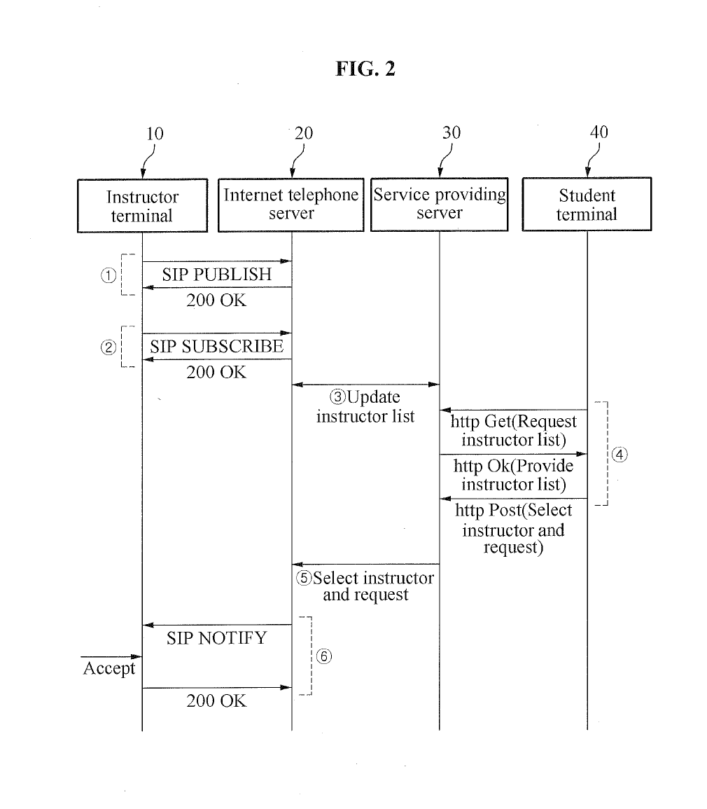

In operation \textcircled{1} of FIG. 2, the instructor expresses an intention to currently provide a lecture. The expression is implemented using a SIP PUBLISH message defined by RFC3903 standard of IETF. The message is used by a terminal or a SIP object to request a change in state information related to a predetermined event, and a presence event (attendance information such as an IP address of the terminal or whether the object is currently logged in and available for a call) is already defined by RFC3856 of IETF. A predetermined event may be added to implement the present invention. For example, a lecture event (an event associated with an Internet lecture) is added, and an xml element of <provice>yes</provide> is added to a body of a publish message, and it is agreed that a corresponding instructor is determined to have an intention to provide a lecture when transmitting the message. In case of the presence event, an XML text format of the message body (Presence Information Data Format (PIDF)) is defined by RFC3863. It may also be implemented using a method of adding an xml element indicating whether the instructor has an intention to provide a lecture to PIDF by incorporating a Lecture event in the presence event, rather than adding the Lecture event. The intention to provide a lecture is expressed through an Initial publish message, and a state of the intention to provide a lecture is extended continuously through a refresh publish message. When the instructor changes his/her mind and has no intention to provide a lecture, the instructor may express that the instructor has no intention to provide a lecture through a remove publish message.

In operation \textcircled{2} of FIG. 2, when a student requests a lecture, a notification of the corresponding information is requested. The request is implemented using a SIP SUBSCRIBEH message defined by RFC3265 standard of IETF. The message is used by the terminal or the SIP object to request a notification with respect to a change in state information related to a predetermined event, and a presence event (attendance information such as an IP address of the terminal or whether the object is currently logged in and available for a call) is already defined. A predetermined event may be added to implement the present invention. For example, a lecture event (an event associated with a telephony lecture) is added, and when a SUBSCRIBE message is transmitted, and an xml element of <lecture><requester>student ID </requester><time> 30 minutes </time> <subject> at airport </subject><question>how to get a ticket </question> </lecture> is added to a body of a NOTIFY message in operation \textcircled{6} of FIG. 2 as a notification service with respect to a future request for a lecture from a student, and an instructor checks a corresponding notification, and accepts the request and provides a lecture if the instructor has an intention to provide the lecture to the predetermined student ID for 30 minutes with respect to content of a question (how to get a ticket) about the subject (at airport) when the message is transmitted. Since the corresponding lecture event is a private event added for the service of the present invention, operation \textcircled{1} of FIG. 2 may be omitted when it is agreed in advance between an Internet telephone server 20 and an instructor terminal 10, and a subscribe message of operation \textcircled{2} may be used by the instructor to express an intention to provide a lecture.

If operation \textcircled{2} of FIG. 2 is omitted, an operation (operation \textcircled{6} of FIG. 2) of notifying the instructor terminal 10 of a request for a lecture prior to a real phone connection may be omitted when a student terminal 40 requests the lecture, and a real phone connection between the instructor terminal 10 and the student terminal 40 may be immediately performed.

In operation \textcircled{3} of FIG. 2, the Internet telephone server 20 shares a list of instructors expressing an intention to currently provide a real-time lecture with a service providing server 30 through an internal protocol other than the SIP or the HTTP. Although the sharing may also be implemented using the SIP or the HTTP, such sharing using the SIP or the HTTP does not have particular advantages over sharing using the internal protocol, and thus the sharing may be implemented using a method preferred by a developer. Among the service configuration blocks of FIG. 1, the Internet telephone server 2 and the service providing server 3 are logically separate concepts and thus, may be physically mounted on the same hardware server or separate from each other. Operation \textcircled{3} is an interaction between the Internet telephone server and the service providing server, which is continuously performed such that whether instructors have an intention to currently provide a lecture, whether the instructors are on the phone (in a lecture), call quality prediction indices of the instructors, and specialized subject field information of the instructors are shared. In case of using the subscribe message of \textcircled{2} of FIG. 2 is used by an instructor to express an intention to provide a lecture when operation \textcircled{1} of FIG. 2 is omitted, the instructor list update operation \textcircled{3} of FIG. 2 is below operation \textcircled{2}. However, in general, when an instructor expresses an intention to provide a lecture in operation \textcircled{1} of FIG. 2, the instructor list update operation of FIG. 2 needs to be below operation \textcircled{1} of FIG. 2.

In operation \textcircled{4} of FIG. 2, a student hoping to take a telephony lecture may check the list of instructors having an intention to currently provide a lecture with respect to a specialized subject field through an Internet browser from the terminal 40. The list of instructors includes whether the instructors are on the phone (in a lecture) and call quality prediction indices as additional information of the instructors. In regard to priorities of the list of instructors, an instructor may be assigned with a high priority when a student having taken a lecture from the instructor designates the instructor as a preferred instructor, or an instructor may be assigned with a high priority for consistency of lecture when an average access time of the instructor matches an average access time of a student. An instructor having a high call quality prediction index may also be assigned with a high priority. Whether an instructor is currently on the phone (in a lecture) may be provided as additional information of the instructor in the list of instructors, or the corresponding instructor may be deleted from the list of instructors. In either case, the student may not request a lecture from the corresponding instructor. The student selects a predetermined instructor depending on a preference, and requests a lecture from the instructor. The http is used for operation \textcircled{4}, and may be replaced by developing an application using an internal protocol.

In operation \textcircled{5} of FIG. 2, the Internet telephone server 20 receives, from the service providing server 30, additional information such as a student ID or service consumer ID, an instructor ID or service provider ID selected by the student, a lecture time, a lecture subject, and a detailed question.

In operation \textcircled{6} of FIG. 2, the Internet telephone server 20 transfers the information received from the service providing server 30 in operation \textcircled{5} to the instructor terminal 10. In this example, in operation \textcircled{2}, the Internet telephone server 20 prepares a SIP NOTIFY message as a part of an event notification response system invoked depending on a system requesting an event notification through a SIP SUBSCRIBE message prepared by the instructor terminal 10, wherein the SIP NOTIFY message with an event header and a body respectively corresponding to a lecture (event) and an xml element of <lecture> <requester> a student ID </requester> <time> 30 minutes </time> <subject> at airport </subject> <question> how to get a ticket </question> </lecture> autonomously defined to use herein is transferred to the instructor terminal 10. The name of Event and the body of the message are merely examples to describe the embodiments, and may be modified to another predetermined name and format. When the instructor terminal 10 received the SIP NOTIFY message, the instructor terminal 10 notifies the instructor of the corresponding information through a message box and receives a request for acceptance or denial. When the instructor accepts, the instructor terminal 10 transfers a 200 OK message to the Internet telephone server 20 such that a phone connection task as shown in FIG. 3 may be performed. When the instructor declines, the instructor terminal 10 transfers a SIP error message (for example: 603 Declined) to deliver the denial. However, when such an error message is transmitted, the event notification request (subscription) established by utilizing the subscribe message in operation \textcircled{2} of FIG. 2 lapses. Thus, when the instructor hopes to receive a request for a lecture from another student, the instructor terminal 10 performs operation \textcircled{2} of FIG. 2 again. To normally complete the SIP Transaction, a SIP Response message should be transmitted within a timer F (non-INVITE transaction timeout timer) having a value 64 times (32 seconds) of t1 having a value of 500 milliseconds (ms) by default, among sip timers defined by RFC 3261. Thus, the instructor terminal 10 waits for a response of acceptance or denial from the instructor for a time of 32 seconds after a notification is provided to the instructor through the popup message box in response to the reception of the NOTIFY message. When there is no response from the instructor, the instructor terminal 10 automatically transmits a response of denial (for example: 603 Declined). When the instructor terminal 10 cannot respond due to a dead battery, it is automatically recognized that the instructor terminal 10 declines to provide a lecture by the timer F.

In operation \textcircled{7} of FIG. 3, when an instructor 11 accepts a request for a lecture, an Internet telephone server 21 notifies a service providing server 31 of corresponding information through an internal protocol. An Internet browser of a student is also notified of the lecture acceptance information through an http 200 ok message or an Asynchronus javascript XML (AJAX). The AJAX is used for an asynchronous interaction between a service providing server and a student terminal. For the notification to a student terminal 41 in operation \textcircled{7} of FIG. 3, the interaction through the AJAX needs to be started in operation \textcircled{4} of FIG. 2. When an internally developed application, rather than the Internet browser, is utilized, the notification is provided from the service providing server 31 to the student terminal 41 by an internal protocol, rather than the http. The internal protocol is configured and transferred in a form of ip header+tcp header+lecture request acceptance notification data or in a form of ip header+udp header+lecture request acceptance notification data.

In operation \textcircled{8} of FIG. 3, a media traffic quality when a phone connection between the instructor 11 and the student 41 is established is predicted. A real RTP packet including forged media DATA may be generated, or a predetermined UDP packet including a forged RTP header as well as forged media DATA may be generated for ease of implementation. However, a call quality prediction through a TCP packet is avoided for the similarity to the real RTP packet. In an example of generating a predetermined UDP packet, the UDP packet is generated in size completely the same as that of an RTP generation packet of a target codec to be used in reality. For example, ULAW transmits 8000-sample data per second separately at an interval of 20 ms (transmits 160 byte*50 data for 1 second). Thus, virtual traffic is generated using a method of generating a UDP packet (UDP packet in size completely the same as that of the real RTP packet) including dummy data of a size the same as 160 byte+the size of (=basic 12 byte+header or extension data included depending on a type of codec) of the RTP header included in the real RTP packet such that both or one of the instructor terminal 11 and the student terminal 41 receives the packet and transfers the same to the other in reality. The packet is generated for a predetermined reference period of time. For example, when ULAW is used and a quality is to be measured for 10 seconds, 500 packets are generated, and a transmission time on the system currently sending each the packets is incorporated in DUMMY data included in each packet. If the instructor terminal 11 generates the packets and transmits the packets to the student terminal 41, the student terminal 41 retransmits the packets as is to the instructor terminal 11 immediately in response to the reception, and the instructor terminal 11 calculates an average Round Trip Time (RTT) by comparing times at which the 500 packets are received and the transmission times included in the DUMMY data of the packets, obtains deviation (degree of separation) values of the average RTT value and RTT values of the packets and the number of lost packets, and predicts a call quality based on a predetermined reference value prepared through experiences using these values.

Similar to the example above, a transmission test session for the call quality prediction is generated through a method of exchanging a SIP Transaction between the instructor terminal 1 and the student terminal 4. That is, through an operation in which the instructor terminal 1 or the student terminal 4 transfers a SIP Transaction Request including a request for the call quality prediction to a counterpart terminal and the counterpart terminal responds to the terminal by incorporating an IP address and a Port number thereof to generate a transmission test session in a SIP Transaction Response, the transmission test session is generated.

A value quantified after the call quality prediction operation is performed (the call quality prediction index) is notified to a student such that the student has an opportunity to select another instructor when the value is less than a predetermined reference value, or such that the student confirms and accepts a phone connection when the value exceeds the predetermined reference value, and then a real phone connection operation is performed. Similar to operation \textcircled{7} of FIG. 3, the Internet browser notifies the student through AJAX, and the internal application notifies the student through the internal protocol. Then, the student terminal notifies the student through a popup message box and receives a response of acceptance or denial.

In operation \textcircled{9} of FIG. 3, an operation of establishing an Internet phone connection between the instructor and the student when an instructor accepts the request for the lecture is illustrated. The instructor terminal 11 may directly and manually performs the phone connection based on student information received in operation \textcircled{6} of FIG. 2. However, the phone connection task or an issue of charging is inconvenient. Thus, the Internet telephone server 21 establishes the phone connection between the instructor 11 and the student 41 using a method of transferring a call of SIP after establishing direct phone connections to the instructor 11 and the student 41. In this example, all SIP messages are set to be through the Internet telephone server 21, and start and end points in time of the phone connection may be accurately determined and thus used usefully for the charging task.

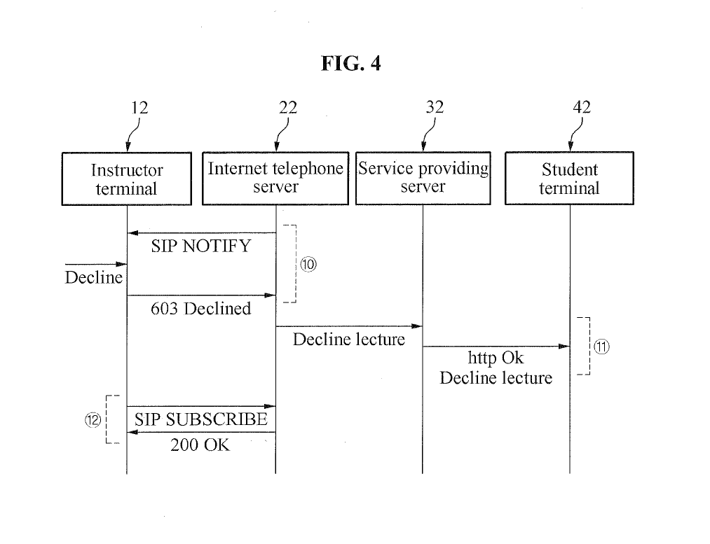

In operation \textcircled{10} of FIG. 4, an example in which an instructor declines a request for a lecture. Operation \textcircled{6} of FIG. 2 corresponds to an example in which an instructor accepts a request for a lecture, and operation 1 of FIG. 4 corresponds to an example in which an instructor declines a request for a lecture. A 603 Declined message, an error message, is transmitted to an Internet telephone server 22 in response to a SIP NOTIFY message, a lecture request notification message, of a student. Various error messages, in addition to the 603 message, are in the SIP message standard. Other error message may also be used if those message are defined in advance between an instructor terminal 12 and the Internet telephone server 22.

In operation \textcircled{11} of FIG. 4, when the instructor 12 declines a lecture or a call quality prediction test fails, corresponding information is transmitted from the Internet telephone server 22 to a service providing server 32 through an internal protocol, and the service providing server 32 transmits an HTTP 200 OK message by incorporating a corresponding denial information message into a body of the HTTP 200 OK message or notifies a student 42 of the denial information using an Asynchronus Javascript XML (AJAX).

In operation \textcircled{12} of FIG. 4, if the instructor continuously has an intention to provide an Internet lecture although the instructor declined a lecture for a previous student for some reasons, the instructor performs operation \textcircled{2} of FIG. 2 again to request a notification of corresponding information when a student requests a lecture.

When a student searches a list of instructors with respect to a specialized subject field that the student is interested in through a service providing server, a classification of the corresponding specialized subject field may not satisfy a degree of precision desired by the student. For example, a subject may be classified in a form of Category: machine, Sub-category: automobile, Sub-sub-category: engine. Even an automobile engine includes numerous components coupled, and a predetermined instructor does not know about all the components of the automobile engine. When a student has a question about a life of an injector part of a diesel engine, the student may request an interactive telephony lecture from an instructor to get an answer to the question. In this example, the student requests a lecture simultaneously from a plurality of instructors expressing an intention to provide a real-time lecture with respect to Sub-sub-category: engine by incorporating a detailed question (I have a question about the life of an injector of a diesel engine) into the request. That is, when a SIP EVENT response system is utilized, the student transfers the detailed question to instructor terminals by incorporating an xml element of <lecture> <requester> a student ID </requester> <time> 30 minutes </time> <subject> engine </subject> <question> I have a question about the life of an injector of a diesel engine </question> </lecture> into a body of a SIP NOTIFY message. When an instructor checks the detailed question included in the lecture request information of the student and determines to provide a lecture since the instructor knows the subject well, the instructor transmits a lecture acceptance response. In this example, since the request for the lecture of the student was transmitted simultaneously to a plurality of instructors, a phone call between the student and an instructor who first transmits a lecture acceptance response is established.

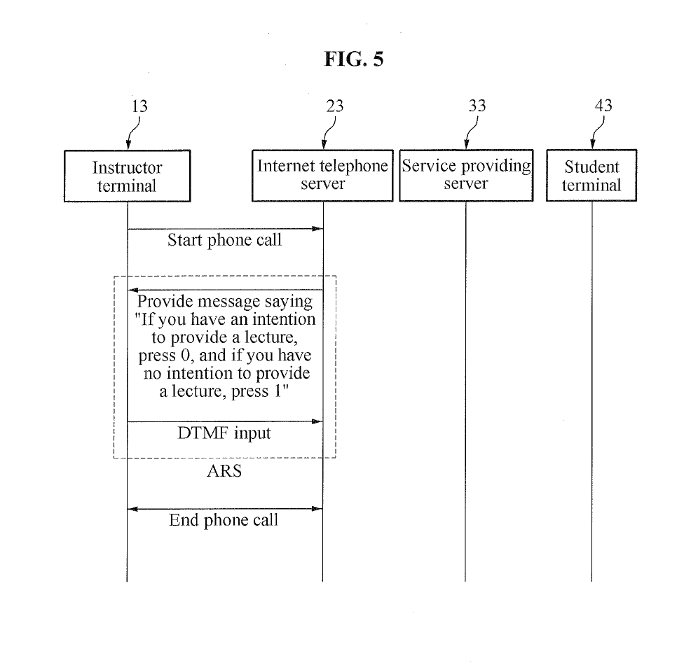

The whole process of FIG. 5 illustrates a method in which an instructor terminal 13 expresses an intention to currently provide a lecture through an Automatic Response

System (ARS) established on an Internet telephone server 23. In this method, a phone number which the instructor terminal 13 requests to call is an extension number assigned in advance to the Internet telephone server 23 in a case of a private telephone network established through IP PBX, or a phone number assigned to the Internet telephone server 23 issued by a telecommunications company in a case of a public telephone network utilizing normal phones. When the instructor terminal 13 connects to the ARS in this manner, the ARS examines whether a caller ID matches the number of the instructor terminal 13 stored along with a specialized subject field through interoperation with a service providing server 33, and provides a corresponding guidance message and ends the call if the numbers do not match. If the instructor is identified, the ARS receives whether the instructor has an intention to currently provide a real-time lecture from the instructor terminal 13 through a DTMF input, and ends the call. Then, a process of updating the list of instructors (adding the instructor to the list of instructors if the instructor has an intention to provide a lecture, or deleting the instructor from the list of instructors if the instructor has no intention to provide a lecture) through interoperation with the service providing server 33, providing the list of instructors with respect to the corresponding subject in response to a request for a lecture from a student 43, notifying a corresponding instructor 13 when the student 43 selects the instructor 13, and connecting a call between the instructor 13 and the student 43 may be performed through the various methods described herein.

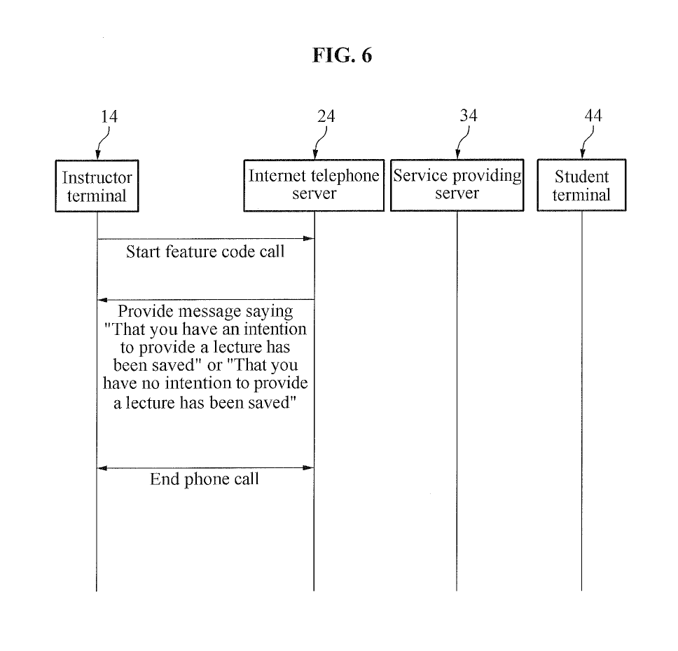

The whole process of FIG. 6 illustrates a method in which an instructor expresses an intention to currently provide a lecture by pressing a predetermined feature code such as “*50”. This method may be divided into a method of assigning a predetermined code to express that an instructor has an intention to provide a lecture and a predetermined feature code to express that an instructor has no intention to provide a lecture, and a method of assigning a predetermined feature code to toggle between two cases.

In the former method, when the predetermined feature code to express that an instructor has an intention to provide a lecture, for example, *50, is pressed, a message saying “That you have an intention to provide a lecture has been saved” is provided, the call is ended, and a state of the corresponding instructor changes to a state of having an intention to provide a lecture. Further, when the predetermined feature code to express that an instructor has no intention to provide a lecture, for example, *51, is pressed, a message saying “That you have no intention to provide a lecture has been saved” is provided, the call is ended, and a state of the corresponding instructor changes to a state of having no intention to provide a lecture.

In the latter method, when the predetermined feature code to toggle between two cases, for example, *60, is pressed while an instructor is in an initial state of having no intention to provide a lecture, a message saying “That you have an intention to provide a lecture has been saved” is provided, the call is ended, and the state of the instructor changes to a state of having an intention to provide a lecture. When the instructor terminal presses *60 again, a message saying “That you have no intention to provide a lecture has been saved” is provided this time, the call is ended, and the state of the instructor changes to a state of having no intention to provide a lecture. In this manner, the state of the instructor changes continuously.

Then, a process of updating the list of instructors (adding the instructor to the list of instructors if the instructor has an intention to provide a lecture, or deleting the instructor from the list of instructors if the instructor has no intention to provide a lecture) through interoperation with a service providing server 34, providing the list of instructors with respect to the corresponding subject in response to a request for a lecture from a student 44, notifying a corresponding instructor 14 when the student 44 selects the instructor 14, and connecting a call between the instructor 14 and the student 44 may be performed through the various methods described herein.

The methods of expressing an intention to provide a lecture described in FIGS. 5 and 6 may also be applied to a SIP Internet telephone and an analog telephone.

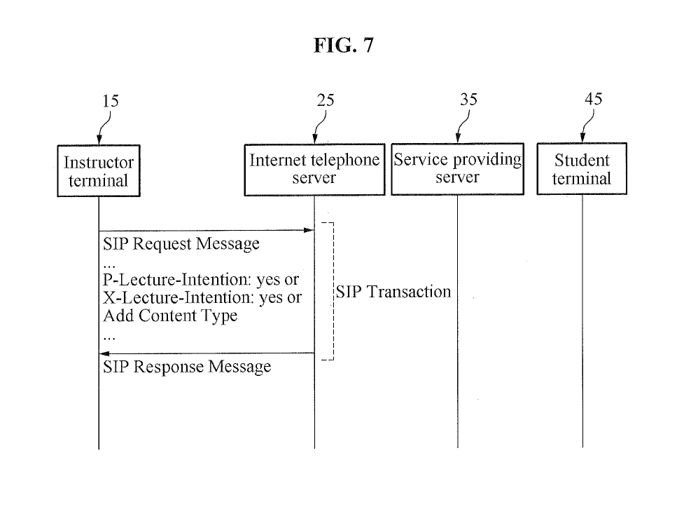

The whole process of FIG. 7 illustrates a method of expressing an intention to provide a lecture using a SIP Transaction.

First, a SIP message may use a nonstandard parameter (header) starting with X- having a meaning of eXperimental or eXtension, or a nonstandard parameter (header) starting with P- having a meaning of Private, Preliminary, or Proprietary to add a new function or characteristic, other than a standardized parameter (header) in a basic protocol. This is utilized to transfer whether an instructor has an intention to provide a lecture (yes or no) by adding the header such as X-Lecture-Intention or P-Lecture-Intention to the SIP Request message for the lecture provision intention expression of the instructor.

An example of using an OPTIONS message, a representative out of dialog message, used for a Ping or an inquiry about Capability of a counterpart SIP object in the SIP is provided below.

OPTIONS sip:carol@chicago.com SIP/2.0

Via: SIP/2.0/UDP pc33.atlanta.com;branch=z9hG4bKhjhs8ass877

Max-Forwards: 70

To: <sip:carol@chicago.com>

From: Alice <sip:alice@atlanta.com>;tag=1928301774

Call-ID: a84b4c76e66710

CSeq: 63104 OPTIONS

Contact: sip:alice@pc33.atlanta.com

X-Lecture-Intention: yes

Accept: application/sdp

Content-Length: 0

Second, it is also possible to add CONTENT for the lecture provision intention expression of the instructor to the SIP Request message, wherein a header such as Content-Type: application/lecture-intention is added to the SIP Request message, and it is possible to express an intention to provide a lecture by describing

Lecture-intention=yes or

Lecture-intention=no

in the content portion.

Similarly, an example of using an OPTIONS message is provided below.

OPTIONS sip: carol@chicago.com SIP/2.0

Via: SIP/2.0/UDP pc33.atlanta.com;branch=z9hG4bKhjhs8ass877

Max-Forwards: 70

To: <sip:carol@chicago.com>

From: Alice <sip:alice@atlanta.com>;tag=1928301774

Call-ID: a84b4c76e66710

CSeq: 63104 OPTIONS

Contact: sip:alice@pc33.atlanta.com

Accept: application/sdp

Content-Type: application/lecture-intention

Content-Length: xxx

Lecture-Intention=yes

Then, a process of updating the list of instructors (adding the instructor to the list of instructors if the instructor has an intention to provide a lecture, or deleting the instructor from the list of instructors if the instructor has no intention to provide a lecture) through interoperation with a service providing server 35, providing the list of instructors with respect to the corresponding subject in response to a request for a lecture from a student terminal 45, notifying a corresponding instructor terminal 15 when the student terminal 45 selects the instructor terminal 15, and connecting a call between the instructor terminal 15 and the student terminal 45 may be performed through the various methods described herein.

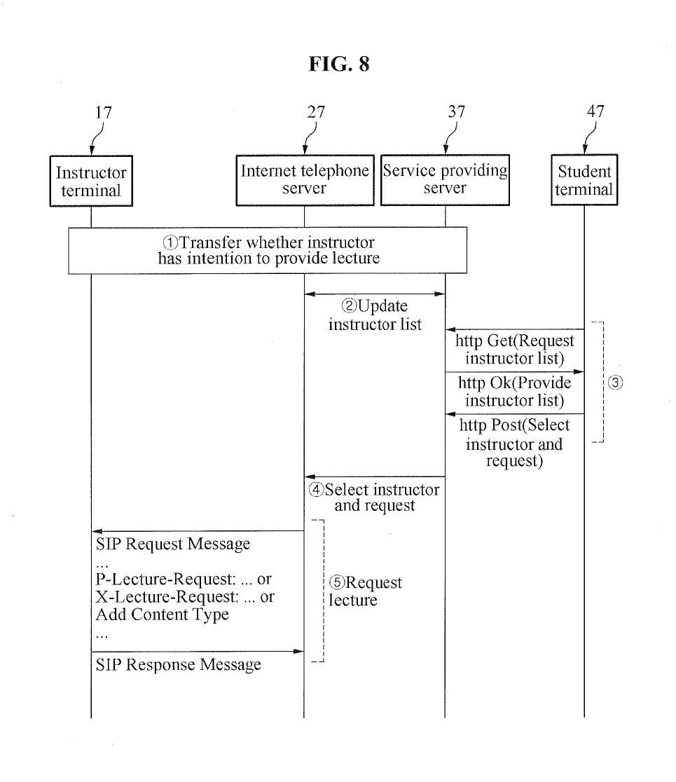

FIG. 8 illustrates a method of using a SIP Transaction to transmit instructor selection and request information of a student to an instructor terminal 17.

In operation \textcircled{1} of FIG. 8, an instructor expresses an intention to currently provide a lecture. The instructor may express an intention to provide a lecture to an Internet telephone server through a SIP Publish message or a general SIP Transaction. After the instructor expresses an intention to provide a lecture, in operation \textcircled{2}, an Internet telephone server 27 and a service providing server 37 update whether an instructor has an intention to provide a lecture for each specialized subject field through interoperation. When the instructor terminal 17 is on the phone (in a lecture), corresponding information is transferred from the Internet telephone server 27 to the service providing server 37 also through operation, and a corresponding instructor deleted from the list of instructors transferred to a student terminal 47 or displayed as being in a lecture.

In operation \textcircled{3} of FIG. 8, a student hoping to take a lecture checks a list of instructors not in a lecture (on the phone) among instructors having an intention to provide a lecture with respect to a subject that the student is currently interested in through an Internet browser or an internally developed application from the student terminal 47, selects, and requests a lecture. In operation \textcircled{4}, lecture request information (an instructor ID, a student ID, a lecture time, a lecture subject, a detailed question) is transferred to the Internet telephone server 27.

In operation \textcircled{5} of FIG. 8, the instructor terminal 17 receives the lecture request information from the Internet telephone server 27, and the instructor confirms the lecture request information and expresses an intention to accept or decline the request for the lecture to the Internet telephone server 27. If the instructor accepts the request for the lecture, the Internet telephone server 27 transfers the corresponding information to the service providing server 37, and the service providing server 37 transfers the same to the student terminal 47 again, in operation \textcircled{7} of FIG. 3. Thereafter, in operation \textcircled{8} of FIG. 3 and operation \textcircled{9} of FIG. 3, a phone connection task between the instructor terminal 17 and the student terminal 47 is performed. If the instructor declines the request for the lecture, the Internet telephone server 27 transfers the corresponding information to the service providing server 37, and the service providing server 37 transfers the same to the student terminal 47 again, in operation \textcircled{11} of FIG. 4.

Operation \textcircled{5} of FIG. 8 illustrates a method in which the Internet telephone server 27 transfers lecture request information of the student terminal 47 to the instructor terminal 17 using a SIP Transaction.

First, similar to the example of the lecture provision intention expression described above, the lecture request information of the student is transferred to the instructor terminal by storing the lecture request information of the student in the SIP Request message using a nonstandard parameter (header) starting with X- or a nonstandard parameter (header) starting with P-. For example, to store the lecture request information of the student, a header such as X-Lecture-Request or P-Lecture-Request is added to the SIP Request message, and a student ID, a lecture subject, a lecture time are stored as content, whereby the SIP Request message is transferred in a form of

“X-Lecture-Request: a student ID; a lecture subject; a lecture time” or

“P-Lecture-Request: a student ID; a lecture subject; a lecture time”.

For example, a SIP Request message including a header such as

X-Lecture-Request: hong-gil-dong; aerodynamics; 3600 sec

is prepared.

Second, it is also possible to add CONTENT to the SIP Request message to store the lecture request information of the student, wherein a header such as Content-Type: application/lecture-request is added to the SIP Request message, and it is possible to transfer the lecture request information by describing

“Lecture-Request=a student ID; a lecture subject; a lecture time”

in the content body portion of the SIP Request message.

For example, a SIP Request message including a header such as

Content-Type: application/lecture-request

Content-Length: xxx(xxx denoting the length of content recorded in the message body)

is prepared, and content such as

Lecture-Request=hong-gil-dong; aerodynamics; 3600 sec

is recorded in the message body portion and transferred.

To normally complete the SIP Transaction, a SIP Response message should be transmitted within a timer F (non-INVITE transaction timeout timer) having a value 64 times (32 seconds) of t1 having a value of 500 ms by default, among sip timers defined by RFC 3261. Thus, the instructor terminal 17 receiving the lecture request information of the student notifies the instructor immediately through a popup message box through an OPTIONS message, and waits for a response from the instructor for a time less than the timer F. When the instructor accepts, the instructor terminal 17 transmits a 200 OK response message. When the instructor declines, the instructor terminal 17 transmits an error response message such as 603 Decline. If no response is received from the instructor for the corresponding time, the instructor terminal 17 automatically transmits the 603 Decline error response message. A process after a response of acceptance or denial is received from the instructor is the same as the examples described above.

Embodiments have been described principally about a telephony lecture such as telephone English. The embodiments may apply to various situations such as knowledge sharing between telephone subscribers or a guidance service through an operator. Further, information to be exposed to an instructor and a student member is not phone numbers, but ID information of the instructor and the student, and mapping information between the real phone numbers and and the IDs is managed by a service providing server, whereby an unnecessary exposure of phone numbers is prevented.

1. A method of connecting a telephone call for a special purpose, the method comprising:
receiving, by an Internet telephone server, a message including intention expression information related to service provision by telephone from a service provider terminal;
confirming, by the Internet telephone server, an intention expression related to service provision by telephone of the service provider by analyzing the message including the intention expression information related to service provision by telephone;
transferring, by the Internet telephone server, information regarding whether the service provider has an intention to provide a telephony service based on the intention expression related to service provision by telephone of the service provider, to a service providing server;
providing, by the service providing server, a list containing the information regarding whether the service provider has an intention to provide a telephony service to a service consumer terminal of a service consumer hoping to receive a telephony service, and receiving a selection with respect to the list from the service consumer terminal;
receiving, by the Internet telephone server, additional information related to at least one of a service consumer ID, a service provider ID selected by the service consumer, a service time, a service subject, and a detailed question corresponding to the selection from the service providing server, and transferring the additional information to the service provider terminal; and
providing, by the Internet telephone server, a phone connection between the service provider terminal and the service consumer terminal after the additional information is confirmed by the service provider terminal.

2. The method of claim 1, wherein the receiving of the message including the intention expression information related to service provision by telephone comprises receiving the intention expression information related to service provision by telephone through a SIP PUBLISH message, and
the confirming of the intention expression related to service provision by telephone comprises confirming whether the service provider has an intention to provide a telephony service by reading out intention expression information related to service provision by telephone in the SIP PUBLISH message designated to express whether the service provider has an intention to provide a telephony service or not, when the intention expression information is received from the service provider terminal.

3. The method of claim 1, wherein the receiving of the additional information and transferring of the additional information to the service provider terminal comprises transferring the additional information to the service provider terminal by adding a header to contain the additional information in a SIP Request message on a SIP Transaction or incorporating the additional information in Content (Body part of SIP message) by Content Type addition.

4. The method of claim 1, wherein the receiving of the message including the intention expression information related to service provision by telephone comprises receiving the intention expression information related to service provision by telephone through a SIP Request message on a first SIP Transaction, and
the confirming of the intention expression related to service provision by telephone comprises determining that the service provider has an intention to provide a telephony service when information indicating an intention to provide a telephony service is present in Content (Body part of SIP message) by Content Type addition or a header added to contain the intention expression information related to service provision by telephone in the SIP Request message on the first SIP Transaction, and determining that the service provider does not have an intention to provide a telephony service when the information indicating an intention to provide a telephony service is absent.

5. The method of claim 1, wherein the receiving of the additional information and transferring of the additional information to the service provider terminal comprises transferring the additional information to the service provider terminal through a SIP event notification request and response system including SIP SUBSCRIBE and SIP NOTIFY messages.
